(19) United States
(12) Patent Application Publication
(10) Pub. No.: US 2018/0233129 A1
(43) Pub. Date: Aug. 16, 2018

(54) ENHANCED AUTOMATIC SPEECH RECOGNITION

(71) Applicant: VocalZoom Systems Ltd., Yokneam IIIit (IL)

(72) Inventors: Tal Bakish, Modi'in (IL); Yekutiel Avargel, Nir Galim (IL); Mark Raifel, Ra'anana (IL)

(21) Appl. No.: 15/510,704

(22) PCT Filed: Jul. 21, 2016
(86) PCT No.: PCT/IB2016/054343

§ 371 Date: Mar. 13, 2017

Related U.S. Application Data
(60) Provisional application No. 62/197,021, filed on Jul. 26, 2015.
(60) Provisional application No. 62/197,022, filed on Jul. 26, 2015.

(51) Int. Cl. G10L 15/06; H04R 23/00; G10L 15/065; G10L 25/06; H04R 3/00

(52) U.S. Cl. CPC G10L 15/063; H04R 23/008; H04R 3/005; G10L 25/06; G10L 15/065

(57) ABSTRACT

Devices, systems, and methods of enhanced automatic speech recognition. An acoustic microphone senses or captures acoustic signals that are uttered by a human speaker. An optical microphone or laser microphone transmits a laser beam aimed towards the face of the human speaker; receives a reflected optical feedback signal; and produces an optical self-mix signal by self-mixing interferometry. The self-mix signal is used by a training unit of a speech recognition processor. Optionally, the self-mix signal is used by an utterance recognition unit of the speech recognition processor. Optionally, the self-mix signal is utilized for enhancing the acoustic signals, or for constructing a digital filter that is applied to the acoustic signal; and the enhanced acoustic signal, or the filtered acoustic signal, is used by the training unit or by the a recognition unit of the speech recognition processor.

### CROSS-REFERENCE TO RELATED APPLICATIONS

This patent application claims priority and benefit from U.S. provisional patent application No. 62/197,021, filed on Jul. 26, 2015, which is hereby incorporated by reference in its entirety.

This patent application claims priority and benefit from U.S. provisional patent application No. 62/197,022, filed on Jul. 26, 2015, which is hereby incorporated by reference in its entirety.

### FIELD

The present invention is related to processing of signals.

### BACKGROUND

Audio and acoustic signals are captured and processed by millions of electronic devices. For example, many types of smartphones, tablets, laptop computers, and other electronic devices, may include an acoustic microphone able to capture audio. Such devices may allow the user, for example, to capture an audio/video clip, to record a voice message, to speak telephonically with another person, to participate in telephone conferences or audio/video conferences, to verbally provide speech commands to a computing device or electronic device, or the like.

### SUMMARY

The present invention may comprise systems, devices, and methods for enhancing and processing audio signals, acoustic signals and/or optical signals, and for enhanced or improved Speech Recognition (SR) or Automatic Speech Recognition (ASR).

The present invention may comprise devices, systems, and methods of enhanced automatic speech recognition. For example, an acoustic microphone senses or captures acoustic signals that are uttered by a human speaker. An optical microphone or laser microphone transmits a laser beam aimed towards the face of the human speaker; receives a reflected optical feedback signal; and produces an optical self-mix signal by self-mixing interferometry. The self-mix signal is used by a training unit of a speech recognition processor. Optionally, the self-mix signal is used by an utterance recognition unit of the speech recognition processor. Optionally, the self-mix signal is utilized for enhancing the acoustic signals, and/or for constructing a digital filter (e.g., a digital comb filter; a linear filter; a non-linear filter; a set of multiple filters; or the like) that is applied to the acoustic signal; and the enhanced acoustic signal, or the filtered acoustic signal, is used by the training unit and/or by the utterance recognition unit of the speech recognition processor.

The present invention may provide other and/or additional benefits or advantages.

### BRIEF DESCRIPTION OF THE DRAWINGS

FIG. 1 is a schematic block-diagram illustration of a system, in accordance with some demonstrative embodiments of the present invention.

FIG. 2 is a schematic block-diagram illustration of another system, in accordance with some demonstrative embodiments of the present invention.

FIG. 3 which is a block-diagram illustration of a stand-alone laser microphone, in accordance with some demonstrative embodiments of the present invention.

FIG. 4 is a block-diagram illustration of a hybrid system, in accordance with some demonstrative embodiments of the present invention.

FIG. 5 is a block-diagram illustration of a vehicle having a vehicular system, in accordance with some demonstrative embodiments of the present invention.

FIGS. 6A-6F are block-diagram illustrations of Speech Recognition systems, in accordance with some demonstrative embodiments of the present invention.

FIG. 7 is a schematic illustration of a chart demonstrating calibration in accordance with some demonstrative embodiments of the present invention.

FIGS. 8A-8B are schematic block-diagram illustrations of systems in accordance with some demonstrative embodiments of the present invention.

FIG. 9 is a schematic illustration of a chart demonstrating Speech Recognition performance, in accordance with some demonstrative embodiments of the present invention.

FIG. 10 is a block-diagram illustration of a system, in accordance with some demonstrative embodiments of the present invention.

### DETAILED DESCRIPTION OF THE PRESENT INVENTION

Applicants have realized that an optical microphone, or a laser-based microphone or a laser microphone, may be utilized in order to enhance or improve Speech Recognition (SR) or Automatic Speech Recognition (ASR) performed on an acoustic signal that is captured by an acoustic microphone, in order to provide better results, improved results, more accurate results, or more reliable results that more reliably correspond to the actual utterances generated by a human speaker.

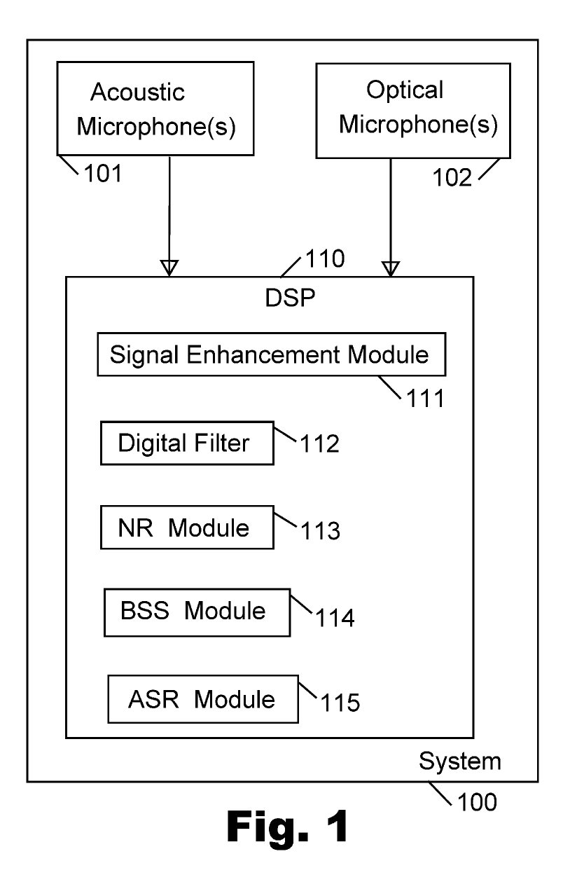

Reference is made to FIG. 1, which is a schematic block-diagram illustration of a system 100 in accordance with some demonstrative embodiments of the present invention. System 100 may be implemented as part of, for example: an electronic device, a smartphone, a tablet, a gaming device, a video-conferencing device, a telephone, a vehicular device, a vehicular system, a vehicular dashboard device, a navigation system, a mapping system, a gaming system, a portable device, a non-portable device, a computer, a laptop computer, a notebook computer, a tablet computer, a server computer, a handheld device, a wearable device, an Augmented Reality (AR) device or helmet or glasses or headset (e.g., similar to Google Glass), a Virtual Reality (VR) device or helmet or glasses or headset (e.g., similar to Oculus Rift), a smart-watch, a machine able to receive voice commands or speech-based commands, a speech-to-text converter, a Voice over Internet Protocol (VoIP) system or device, wireless communication devices or systems, wired communication devices or systems, image processing and/or video processing and/or audio processing workstations or servers or systems, electro-encephalogram (EEG) systems, medical devices or systems, medical diagnostic devices and/or systems, medical treatment devices and/or systems, and/or other suitable devices or systems. In some embodiments, system 100 may be implemented as a stand-alone unit or “chip” or module or device, able to capture audio and able to output enhanced audio, clean audio, noise-reduced audio, or otherwise improved or modified audio. System 100 may be implemented by utilizing one or more hardware components and/or software modules.

System 100 may comprise, for example: one or more acoustic microphone(s) 101; and one or more optical microphone(s) 102. Each one of the optical microphone(s) 102 may be or may comprise, for example, a laser-based microphone; which may include, for example, a laser-based transmitter (for example, to transmit a laser beam, e.g., towards a face or a mouth-area of a human speaker or human user, or towards other area-of-interest), an optical sensor to capture optical feedback returned from the area-of-interest; and an optical feedback processor to process the optical feedback and generate a signal (e.g., a stream of data; a data-stream; a data corresponding or imitating or emulating n audio signal or an acoustic signal) that corresponds to that optical feedback.

The acoustic microphone(s) 101 may generate one or more acoustic signal(s); and the optical microphone(s) 102 may generate one or more optical signal(s). The signals may be utilized by a digital signal processor (DSP) 110, or other controller or processor or circuit or Integrated Circuit (IC). For example, the DSP 110 may comprise, or may be implemented as, a signal enhancement module 111 able to enhance or improve the acoustic signal based on the receives signal; a digital filter 112 able to filter the acoustic signal based on the received signals (e.g., implemented as a stand-alone module or unit, or as part of the signal enhancement module 111, or as a sub-unit of the signal enhancement module 111); a Noise Reduction (NR) module 113 able to reduce noise from the acoustic signal based on the received signals; a Blind Source Separation (BSS) module 114 able to separate or differentiate among two or more sources of audio, based on the receives signals; a Speech Recognition (SR) or Automatic Speech Recognition (ASR) module 115 able to recognize spoken words based on the received signals; and/or other suitable modules or sub-modules.

In the discussion herein, the output generated by (or the signals captured by, or the signals processed by) an Acoustic microphone, may be denoted as “A” for Acoustic; or may be denoted as “At” as acoustic signals used for Training of SR/ASR modules or for training session or learning sessions that train or prepare an SR/ASR module for subsequent recognition; or may be denote as “Ar” as acoustic signals used for Recognition of speech by an SR/ASR module that has already been trained, or that operates subsequently to a training session or subsequently to a training processes or subsequently to a learning process. Accordingly, it would be appreciated that even if a particular drawing, for example, depicts a first acoustic signal (such as At) and a second acoustic signal (Ar), such acoustic signals may be generated and/or transferred and/or processed at different time-points or at different times, and may not be the same acoustic signal; for example, a first acoustic signal (At) may be used for SR/ASR training at a certain time or day or time-slot; and subsequently, or once the SR/ASR module is trained or is sufficiently trained, a second, different, subsequent acoustic signal (Ar) may be used for actual recognition by the SR/ASR module.

In the discussion herein, the output generated by (or the signals captured by, or the signals processed by) an Optical (or laser-based) microphone, may be denoted as “O” for Optical; or may be denoted as “Ot” as optical signals used for Training of SR/ASR modules or for training session or learning sessions that train or prepare an SR/ASR module for subsequent recognition; or may be denote as “Or” as optical signals used for Recognition of speech by an SR/ASR module that has already been trained, or that operates subsequently to a training session or subsequently to a training processes or subsequently to a learning process. Accordingly, it would be appreciated that even if a particular drawing, for example, depicts a first optical signal (such as Ot) and a second optical signal (Or), such optical signals may be generated and/or transferred and/or processed at different time-points or at different times, and may not be the same optical signal; for example, a first optical signal (Ot) may be used for SR/ASR training at a certain time or day or time-slot; and subsequently, or once the SR/ASR module is trained or is sufficiently trained, a second, different, subsequent optical signal (Or) may be used for actual recognition by the SR/ASR module.

Although portions of the discussion herein may relate to, and although some of the drawings may depict, a single acoustic microphone, or two acoustic microphones, it is clarified that these are merely non-limiting examples of some implementations of the present invention. The present invention may be utilized with, or may comprise or may operate with, other number of acoustic microphones, or a batch or set or group of acoustic microphones, or a matrix or array of acoustic microphones, or the like.

Although portions of the discussion herein may relate to, and although some of the drawings may depict, a single optical (laser-based) microphone, or two optical (laser-based) microphones, it is clarified that these are merely non-limiting examples of some implementations of the present invention. The present invention may be utilized with, or may comprise or may operate with, other number of optical or laser-based microphones, or a batch or set or group of optical or laser-based microphones, or a matrix or array of optical or laser-based microphones, or the like.

Although portions of the discussion herein may relate, for demonstrative purposes, to two “sources” (e.g., two users, or two speakers, or a user and a noise, or a user and interference), the present invention may be used in conjunction with a system having a single source, or having two such sources, or having three or more such sources (e.g., one or more speakers, and/or one or more noise sources or interference sources).

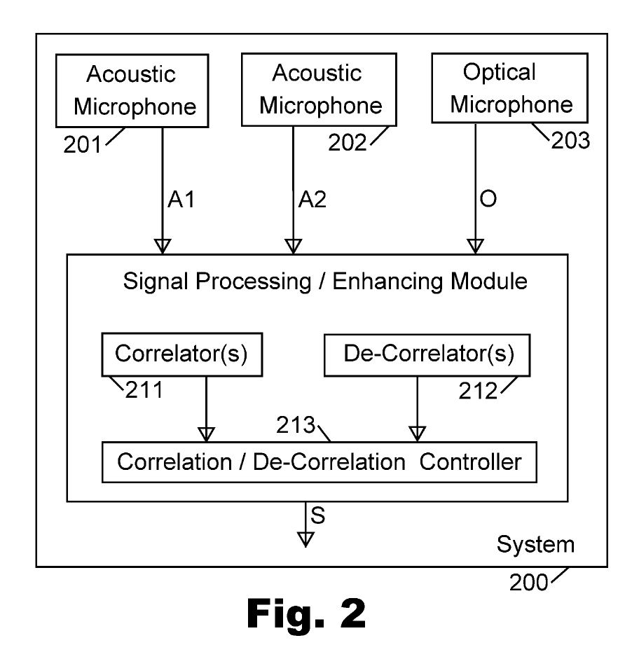

Reference is made to FIG. 2, which is a schematic block-diagram illustration of a system 200 in accordance with some demonstrative embodiments of the present invention. Optionally, system 200 may be a demonstrative implementation of system 100 of FIG. 1.

System 200 may comprise a plurality of acoustic microphones; for example, a first acoustic microphone 201 able to generate a first signal Al corresponding to the audio captured by the first acoustic microphone 201; and a second acoustic microphone 202 able to generate a second signal A2 corresponding to the audio captured by the second acoustic microphone 202.

System 200 may further comprise one or more optical microphones; for example, an optical microphone 203 aimed towards an area-of-interest, able to generate a signal O corresponding to the optical feedback captured by the optical microphone 203.

A signal processing/enhancing module 210 may receive as input: the first signal A1 of the first acoustic microphone 201, and the second signal A2 of the second acoustic microphone, and the signal O from the optical microphone. The signal processing/enhancing module 210 may comprise one or more correlator(s) 211, and/or one or more de-correlators 212, and/or other suitable comparators, matching units, matching modules, or mutual information finder modules; which may perform one or more, or a set or series or sequence of, correlation operations and/or de-correlation operations, on the received signals or on some of them or on combination(s) of them, as described herein, based on correlation/decorrelation logic implemented by a correlation/decorrelation controller 213; in order to achieve a particular goal, for example, to reduce noise(s) from acoustic signal(s), to improve or enhance or clean the acoustic signal(s), to distinguish or separate or differentiate among sources of acoustic signals or among speakers, to distinguish or separate or differentiate between a speaker (or multiple speakers) and noise or background noise or ambient noise, to operate as digital filter on one or more of the received signals, and/or to perform other suitable operations. The signal processing/enhancing module 210 may output an enhanced reduced-noise signal S, which may be utilized for such purposes and/or for other purposes, by other units or modules or components of system 200, or by units or components or modules which may be external to (and/or remote from) system 200.

Applicants have realized that the data captured by a laser-based microphone or by an optical microphone, may be utilized during a training phase or training session(s) of an SR system or an ASR system; instead of merely utilizing acoustic data for such SR/ASR training, or in addition to utilizing acoustic data for such SR/ASR training; or in a manner that fuses together the optically-captured data with acoustic data and then utilizes the fused data for such SR/ASR training.

Accordingly, some embodiments of the present invention may utilize the optical microphone or laser microphone in order to improve or enhance or modify the data that is captured by the acoustic microphone(s), or to modify or improve or enhance the spectral or spectrum-related characteristics of the acoustically-sensed signals, thereby improving or enhancing the SR/ASR training process and/or the SR/ASR processing itself, and thereby increasing the rate or number of words or utterances or phrases that such SR/ASR process is able to accurately recognize.

In some embodiments of the present invention, the system may analyze the relation between (i) the low frequencies in the optical signal, and (ii) at least some of the frequencies in the acoustic signal that the SR/ASR module recognizes or utilizes; and may generate, based on the optical signal, a digital filter that operates on the high frequencies, thereby improving or enhancing the performance of the SR/ASR module, in the training phase and/or in the actual recognition processing phase. In other embodiments, the system may analyze the relation between (i) the low frequencies in the optical signal (or a subset or portion of those frequencies), and (ii) all the frequencies in the acoustic signal (or a subset of portion of those frequencies) that the SR / ASR module recognizes or utilizes) thereby improving the performance of the SR/ASR module, in the training phase and/or in the actual recognition processing phase. The “relation” mentioned above may be, for example, a correlation or matching or corresponding characteristics or patterns or attributes; or conversely, maybe de-correlation or non-matching or non-corresponding characteristics or patterns or attributes.

In accordance with some demonstrative embodiments of SR/ASR improvement, an SR/ASR module may perform SR/ASR training based exclusively on the optical signal that was captured by the optical microphone; without performing any SR/ASR training that is based on acoustic signal(s) or audio signal(s); without performing any SR/ASR training that is based on signal(s) captured by any acoustic microphone(s). Subsequently, the actual real-time SR/ASR process, may be performed on optically-sensed data from the optical microphone only; or, in another implementation, the subsequent SR/ASR process may be performed on a fusion of (i) optically-sensed data from the optical microphone and (ii) acoustically-sensed signal sensed by the acoustic microphone.

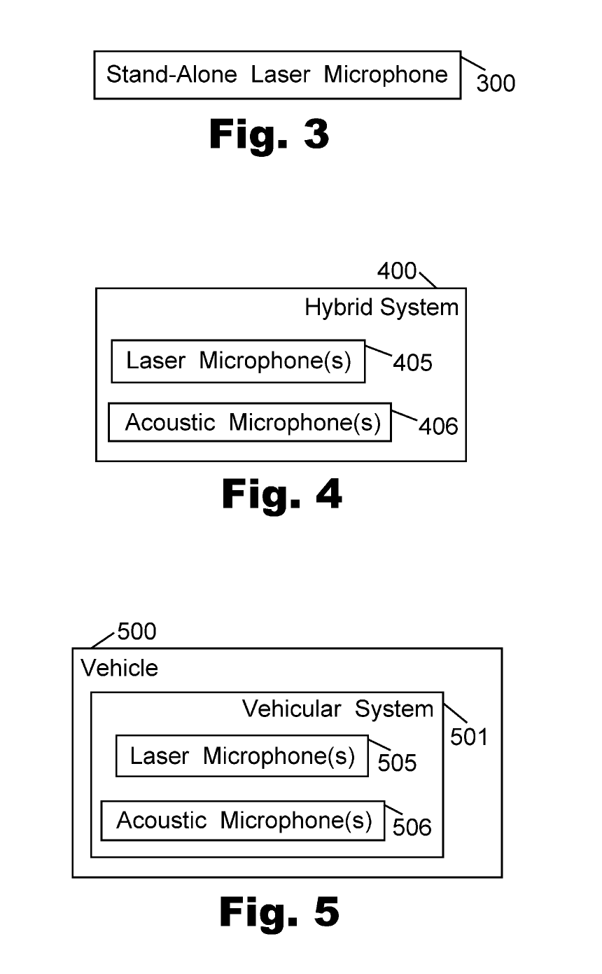

Some embodiments of the present invention may be utilized in conjunction with the component(s) depicted in FIG. 3, which is a block-diagram illustration demonstrating a stand-alone device of laser microphone 300 or laser-based microphone or optical microphone, in accordance with some embodiments of the present invention.

Some embodiments of the present invention may be utilized in conjunction with the component(s) depicted in FIG. 4, which is a block-diagram illustration demonstrating a combined or hybrid system 400, which comprises one or more laser microphone(s) 405 and one or more acoustic microphone(s) 406, in accordance with the present invention.

Some embodiments of the present invention may be utilized in conjunction with the component(s) depicted in FIG. 5, which is a block-diagram illustration demonstrating a vehicle 500 having a vehicular system 501 which comprises one or more laser microphone(s) 505 and one or more acoustic microphone(s) 506, in accordance with the present invention.

The present invention may be utilized in conjunction with other suitable systems and devices, which may be stand-alone, hybrid, integrated, monolithic, co-located, distributed, or may utilize other suitable architectures.

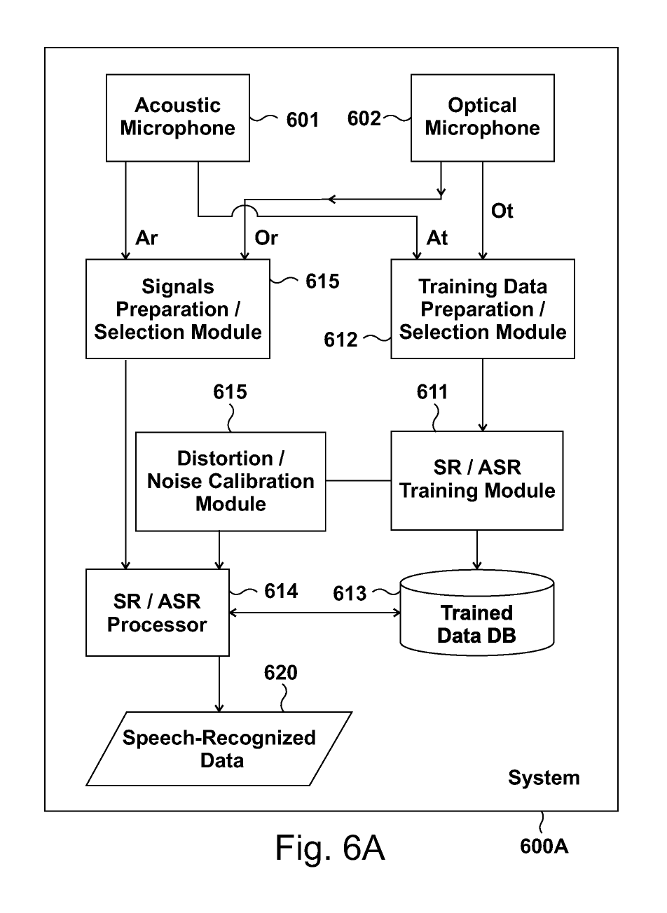

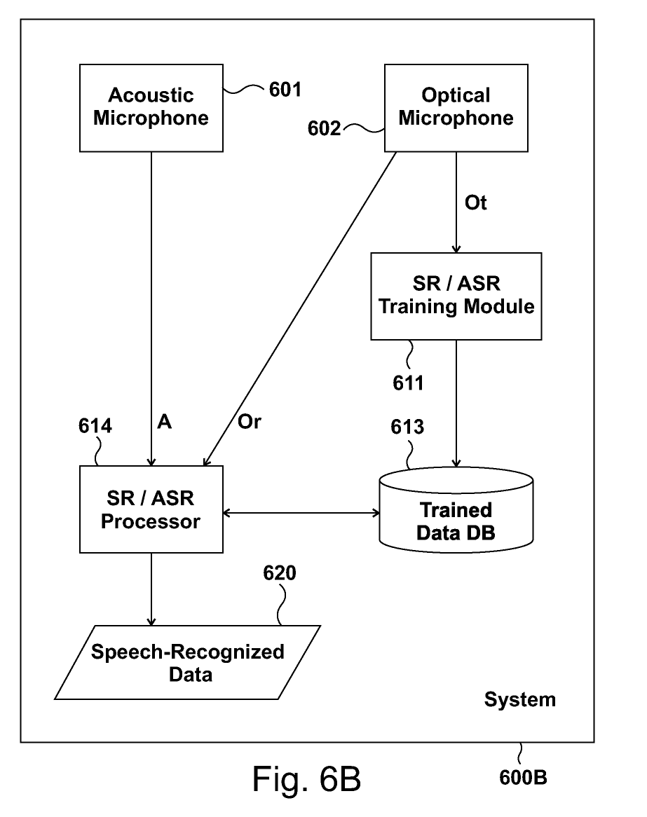

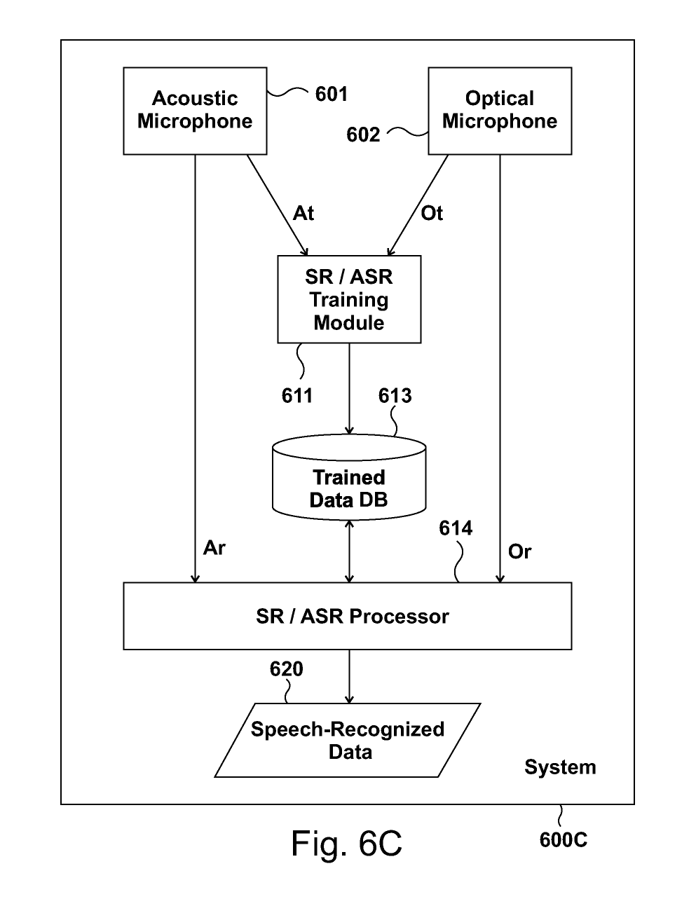

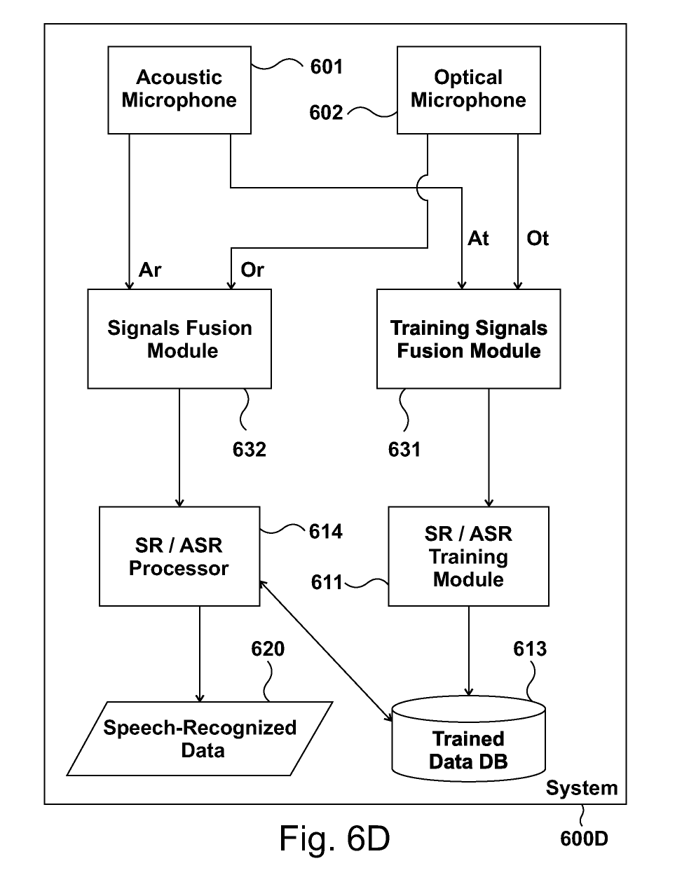

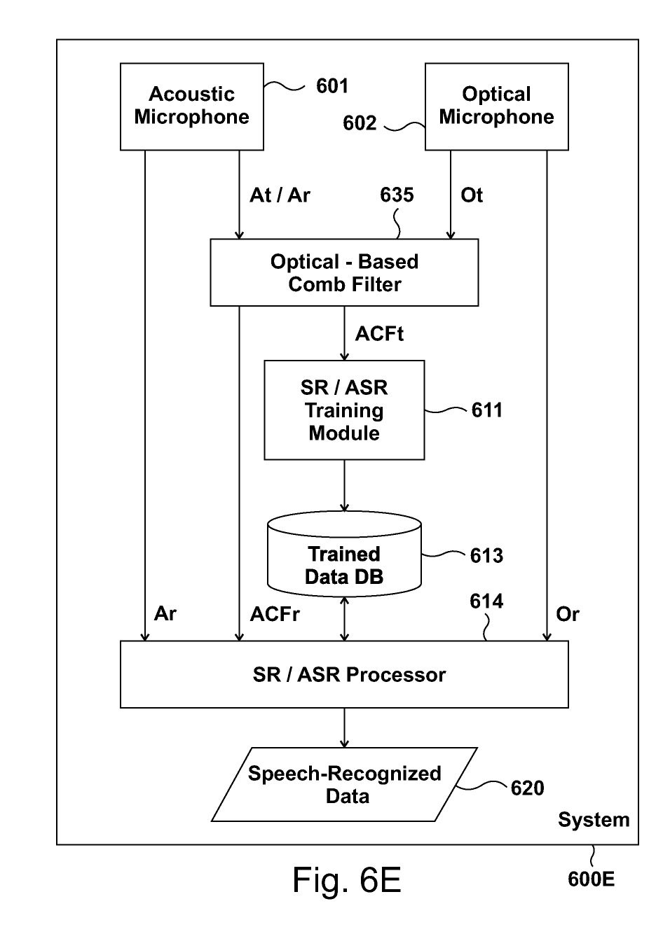

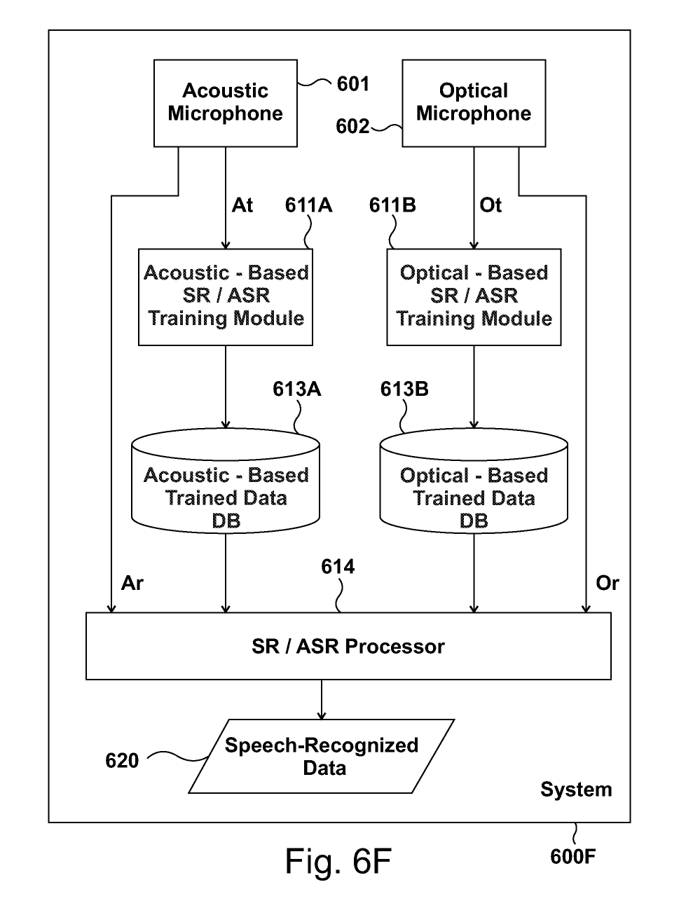

Reference is made to FIG. 6A, which is a schematic block-diagram illustration of a system 600A in accordance with some demonstrative embodiments of the present invention. System 600A may comprise, for example: an acoustic microphone 601 able to sense acoustic data, and producing an acoustic-based signal A; and an optical microphone 602 (e.g., a laser-based microphone or laser microphone) able to sense optical feedback data (e.g., reflected back from a face of a human speaker that the optical microphone is targeting or is aiming towards) and producing an optical-based signal O.

In accordance with the present invention, at least one of the signals A and/or 0, or a combination of those signals, or data prepared based on one of those signals or based on both of those signals, may be utilized as Training Data for an SR/ASR training module 611. The signals are depicted in FIG. 6A with “Ot” (Optical signal for Training purposes) and “At” (Acoustic signal for Recognition purposes).

Optionally, a training data preparation/selection module 612 may prepare or may select the type of signal(s) that will be used for SR/ASR training; for example, only the optical signal, or only the acoustic signal, or both of the signal, or a particular pre-defined combination or weighted combination or other formula that takes into account one of the signals or both of the signals based on pre-defined weights or ratio, or based on dynamically-determined weights or ratio.

During or upon training, the SR/ASR training module 611 may update or augment a trained data database 613, which may store representations of the trained data, or other representations or generated rules or generated insights that may enable or may facilitate subsequent real-time processing of signals and real-time or non-real-time (e.g., retrospective) SR/ASR processes.

Subsequent to the SR/ASR training, an SR/ASR processor 614 may perform real-time or retrospective SR/ASR, based on rules or definitions or trained-data that was accumulated in the previous training session(s), and/or based on other pre-defined or dynamically-changing SR/ASR rules or definitions. The SR/ASR processor 614 may operate, for example, on acoustically-sensed signals only (denoted as “Ar”, Acoustic signal for Recognition); or on optically-sensed signals only (denoted as “Or”, Optical signal for Recognition); or on a combination or fusion or weighted combination that takes into account both of these signals or one of these signals. The SR/ASR processor 614 may generate or may output speech-recognized data 620, for example, speech-recognized words, speech-recognized sentences, or other speech-recognized utterances (e.g., in textual format, as packets or bytes indicating words in a natural language, as pointers to particular locations in a dictionary file, and/or in other suitable formats).

Optionally, a signals preparation/selection module 615 may prepare or may select the type of signal(s) that will be used for the SR/ASR processing; for example, only the optical signal, or only the acoustic signal, or both of the signals, or a particular pre-defined combination or weighted combination or other formula that takes into account one of the signals or both of the signals.

Optionally, a distortion/noise calibration module 616 may be utilized, in order to calibrate or fine-tune the performance of the SR/ASR training module 611 and/or the SR/ASR processor 614.

Reference is made to FIG. 6B, which is a schematic block-diagram illustration of a system 600B in accordance with some demonstrative embodiments of the present invention. System 600B may be generally similar to system 600A; however, in system 600B, the SR/ASR training module 611 performs SR/ASR training exclusively based on the optical signal Or; whereas the SR/ASR processor 614 subsequently performs SR/ASR based on both the acoustic signal (A) and the optical signal (O), as well as based on the trained data database 613. In some embodiments, system 600B may utilize only the optical signal (O) for SR/ASR training (and/or for subsequent SR/ASR processing), thereby utilizing a clean signal that does not contain random noise

Reference is made to FIG. 6C, which is a schematic block-diagram illustration of a system 600C in accordance with some demonstrative embodiments of the present invention. System 600C may be generally similar to system 600A; however, in system 600C, the SR/ASR training module 611 performs SR/ASR training based on two inputs: the optical signal (Ot), and the acoustic signal (At). Subsequently, the SR/ASR processor 614 performs SR/ASR based on both the acoustic signal (Ar) and the optical signal (Or), as well as based on the trained data database 613.

In another implementation, the SR/ASR processor 614 may perform SR/ASR based only on the acoustic signal (Ar), or may perform SR/ASR based only on the optical signal (Or); or may perform SR/ASR based on a fusion or combination or weighted combination of these two signals (Or and Ar); or may perform SR/ASR based on the acoustic signal (Ar) after it has been digitally filtered by utilizing data from the optical signal. In some embodiments, system 600C may utilize the optical signal Or to augment or increase the data in low frequencies, thereby improving or enhancing the SR/ASR process.

Reference is made to FIG. 6D, which is a schematic block-diagram illustration of a system 600D in accordance with some demonstrative embodiments of the present invention. System 600D may be generally similar to system 600A; however, in system 600D, during a training phase, a training signals fusion module 631 may perform audio-visual fusion of the acoustic signal (At) and the optical signal (Ot), which may then be utilized for SR/AST training.

Optionally, during the SR/ASR actual recognition stage (subsequent to one or more training sessions), a signals fusion module 632 may subsequently perform audio-visual fusion of the acoustic signal (Ar) and the optical signal (Or), for example, by using the same fusion algorithm as utilized by the training signals fusion module 631, or by using a different fusion algorithm; and the fused audio-visual signals may then be utilized for speech recognition by the SR/ASR processor 614, in conjunction with the trained data database 613.

Reference is made to FIG. 6E, which is a schematic block-diagram illustration of a system 600E in accordance with some demonstrative embodiments of the present invention. System 600E may be generally similar to system 600A; however, in system 600E, an optical-based comb filter 635 may utilize the optical signal (Ot) to operate as a digital comb filter on the acoustic signal (At), thereby producing an acoustic comb-filtered signal (ACF) for training purposes (denoted ACFt); which may then be fed as input to the SR/ASR training module 611. It is noted that the optical-based comb filter 635 is depicted and is discussed herein only as a non-limiting example; and other type(s) of digital filters may be constructed and applied to the acoustic signal, for example, a linear filter, a non-linear filter, a set of two or more filters, or the like; and accordingly, such Filtered Acoustic Signal may also be denoted as FAS, interchangeably with ACF which is only a non-limiting example.

Subsequent to the training, during the speech recognition phase, the SR/ASR processor 614 may receive as input, one or more of: (i) the acoustic signal (Ar), and/or (ii) the optical signal (Or), and/or (iii) the acoustic comb-filtered signal (denoted ACFr) (or, the Filtered Acoustic Signal, FASr).

In system 600E, the optical-based signal or the optical feedback signal (O) is used for performing a comb filter (or other type of filter) on the acoustic signal; thereby producing a clean or noise-reduced acoustic signal. The clean acoustic signal may have distortion (e.g., may not be easily understandable to a human listener); but may exclude the random factor, namely the noise. Accordingly, the SR/ASR may be trained to handle the “corrupted” or distorted audio or acoustic signal better than utilizing an acoustic signal having noise: noise is not trainable since it is random and does not repeat itself. This method utilizes a clean acoustic signal, without random noise; having spectral bandwidth of the original acoustic signal; although the signal may be distorted (e.g., having less information in the spectral domain). Such “distorted” acoustic signal is more predictable and/or more trainable or more useful for purposes of SR/ASR training and/or SR/ASR processing. Although some information may be lost in the spectral domain due to the distortion, the method may improve the predictability in the time domain. The predictability of a signal has significant impact on the SR/ASR recognition rate. For example, the higher layers (e.g., above the acoustic layers) of the SR/ASR process are language model and topic model; and the present invention may enable the SR/ASR system to gain the predictability already at very low level, at the acoustic signal level.

Reference is made to FIG. 6F, which is a schematic block-diagram illustration of a system 600F in accordance with some demonstrative embodiments of the present invention. System 600F may be generally similar to system 600A; however, in system 600F, optical-based SR/ASR training may be performed in parallel to acoustic-based SR/ASR training, as two separate chains. For example, an optical-based SR/ASR training module 611B may perform SR/ASR training based on the optical signal (Ot), and may update or feed or populate or construct an optical-based trained-data database 613B. Similarly, an acoustic-based SR/ASR training module 611A may perform SR/ASR training based on the acoustic signal (At), and may update or feed or construct or populate an acoustic-based trained-data database 613A. The two databases 613A and 613B may then be utilized by the SR/ASR processor 614; which may receive as input, for example, the acoustic signal (Ar), or the optical signal (Or), or both of these two signals (Ar and also Or).

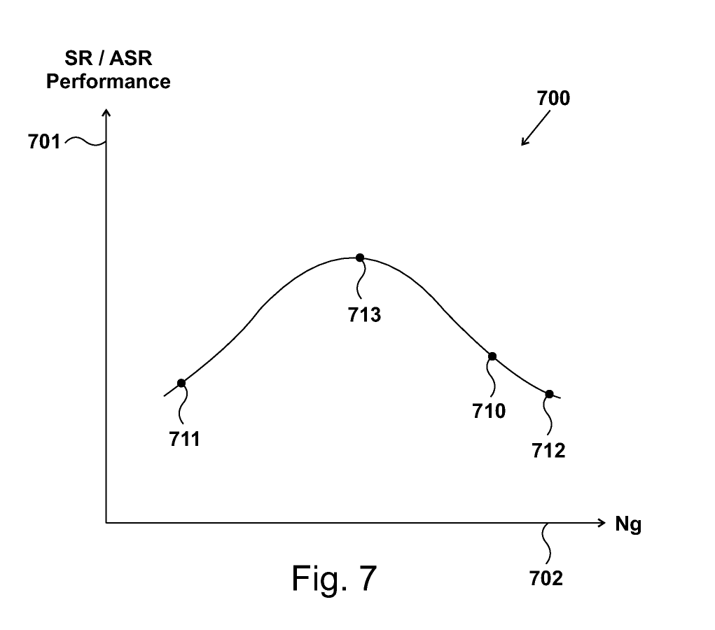

Reference is made to FIG. 7, which is a schematic illustration of a chart 700 demonstrating calibration in accordance with some demonstrative embodiments of the present invention. In chart 700, the vertical axis 701 indicates SR/ASR performance (e.g., higher values indicate better performance); and the horizontal axis 702 indicates the noise in the enhanced signal (e.g., the acoustic signal being enhanced, or comb-filtered, by the optical signal).

As demonstrated by line 710, when the enhancement of the acoustic signal is too low (point 711, too much distortion in the combed acoustic signal) or is too high (point 712, too much noise added to the acoustic signal due to the comb filtering or due to other filtering), then the SR/ASR performance is relatively low; however, there is a region or a point (e.g., point 713, optimal working point) in which the enhancement of the acoustic signal creates the optimal amount of noise that enables maximal performance of the SR/ASR on such signal.

In some embodiments, the SR/ASR system may be calibrated or configured, manually or automatically, in order to determine the optimal working point (713) and in order to enhance the acoustic signal (e.g., based on the optical feedback signal) exactly to the degree that would make it most useful for SR/ASR purposes, and not beyond that point (713).

In a demonstrative implementation, multiple iterations of training may be automatically performed, utilizing different levels of enhancement of the acoustic signal based on the optical signal, in order to calibrate the system and to determine the optimal working point for a particular human speaker and/or of a particular environment (e.g., vehicular environment; office environment) and/or of a particular set of system components (e.g., for the particular acoustic microphone being used, and the particular optical microphone being used).

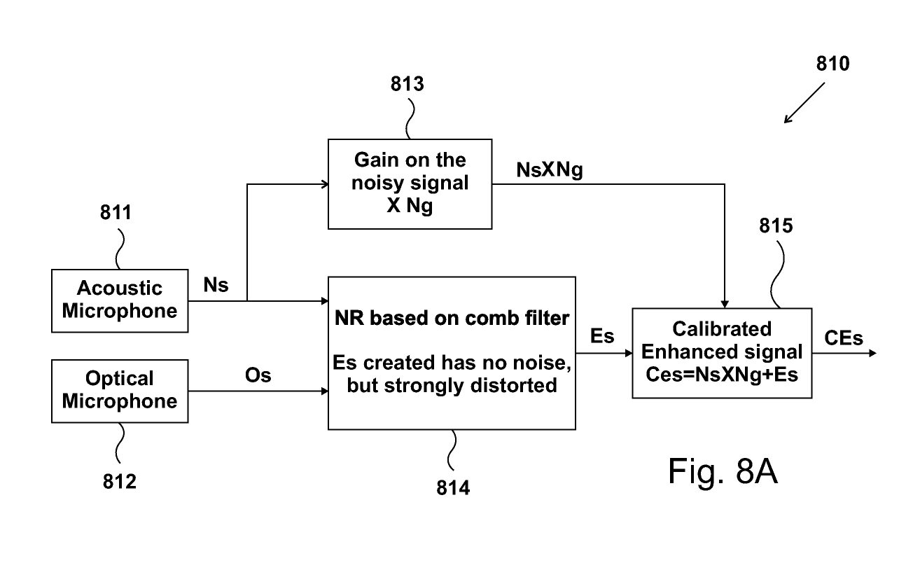

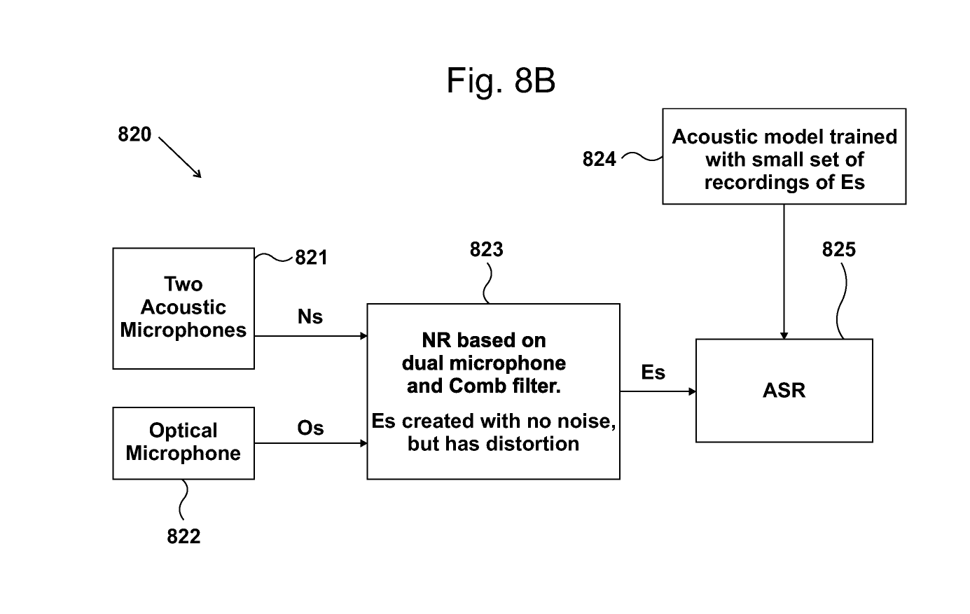

Reference is made to FIG. 8A, which is a schematic block-diagram illustration of a system 810 in accordance with some demonstrative embodiments of the present invention. System 810 may comprise an acoustic microphone 811, and an optical microphone 812. The optical signal may be utilized as a noise-reducing comb filter (or other type of filter) on the acoustic signal (box 814), thereby producing an enhanced acoustic signal that has no noise (but may be distorted). The original (noisy) acoustic signal may be gained or amplified (box 813), and then may be used to calibrate the enhanced signal (box 815). The enhanced calibrated signal may then be utilized for SR/ASR training and/or for SR/ASR processing.

Reference is made to FIG. 8B, which is a schematic block-diagram illustration of a system 820 in accordance with some demonstrative embodiments of the present invention. System 820 may comprise a set of two acoustic microphones 821, and an optical microphone 822. The optical signal may be utilized as a noise-reducing comb filter (or other type of filter) on the acoustic signals (box 823), thereby producing an enhanced acoustic signal that has no noise (but may be distorted). The enhanced acoustic signal may then be utilized for SR/ASR training and/or for SR/ASR processing (box 825). In some implementations, the SR/ASR processor may utilize an acoustic model trained with a small set of recordings of the enhanced acoustic signal (box 824).

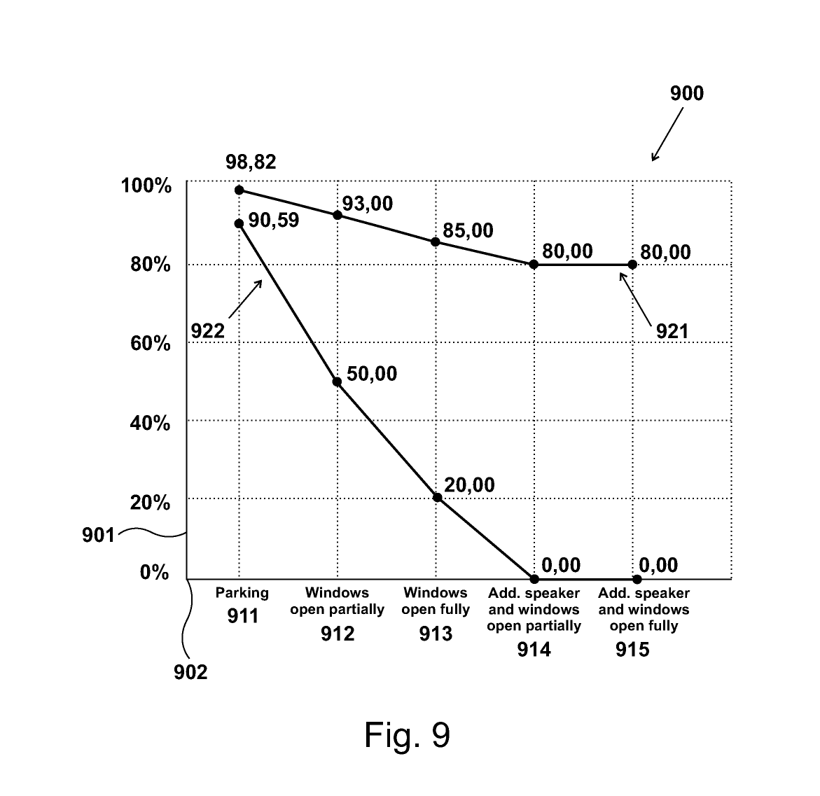

Reference is made to FIG. 9, which is a schematic illustration of a chart 900 demonstrating SR/ASR performance in accordance with some demonstrative embodiments of the present invention. In chart 900, the vertical axis 901 indicates five scenarios that were tested by the Applicants in a demonstrative experiment. The five scenarios 911-915 are: ASR within a parking vehicle with closed windows (911); ASR within a vehicle with windows open partially (912); ASR within a vehicle with windows open fully (913); ASR of a first user who speaks within a vehicle when an additional speaker is present and speaking and when the windows are partially open (914); ASR of a first user who speaks within a vehicle when an additional speaker is present and speaking and when the windows are fully open (915). In scenarios 912-915, the vehicle was driving at a speed of approximately 60 miles-per-hour.

Line 922 indicates the experiment results when SR/ASR was performed by utilizing only a convention acoustic microphone. Line 921 indicates the experiment results when SR/ASR was performed by utilizing a combination of acoustic microphone and optical microphone in accordance with a demonstrative implementation of the present invention.

As demonstrated in chart 900, Line 921 is consistently higher than Line 922. As shown, the present invention's performance (Line 921, over scenario 911) reached a peak of 98.82 percent of success, compared to only 90.59 percent of success in the conventional method (Line 922, over scenario 911). Furthermore, the success rate of the conventional ASR system dropped significantly to 50% in scenario 912; while the performance of the present invention's ASR has achieved 93 percent of success at that scenario 912. Additionally, the success rate of the conventional ASR system dropped significantly to 20% in scenario 913; while the performance of the present invention's ASR has achieved 85 percent of success at that scenario 913. Finally, the success rate of the conventional ASR system dropped to zero percent of success in scenarios 914 and 915; while the performance of the present invention's ASR has achieved 80 percent of success at those scenarios 914 and 915. These non-limiting experimental results are for demonstrative purposes only; and other suitable results, success rates, or benefits may be achieved by using various embodiments of the present invention.

Other implementations may be used in accordance with the present invention. For example, some embodiments may isolate the first human speaker; or may isolate any signal other than the first human speaker (e.g., an interference, an ambient noise, an environmental noise, the utterances of a second speaker, or the like). In a demonstrative embodiment, the system may be used in order to replace background noises or background speaker(s) of a first type, with background noises or background speaker(s) of a second type. For example, the User may speak to his smartphone in a restaurant with background noise that characterizes restaurants; and the system may isolate the speech, and may add to it background noise that characterizes a different environment (e.g., a soccer game, or a sporting event, or an outdoor venue, or being located in a foreign country).

In some embodiments of the present invention, SR/ASR may be performed by utilizing the optical signal but not necessarily for training purposes. For example, the optical signal may not necessarily be utilized for SR/ASR training, and/or the optical signal may not necessarily be utilized for actual or direct SR/ASR recognition; but rather, the optical signal may be utilized in order to provide to the SR/ASR engine or module or processor additional data or meta-data which may be useful in SR/ASR processing and/or which may reduce or restrict the search-space that the SR/ASR processor needs to search, thereby enhancing the SR/ASR recognition results and/or efficiency and/or accuracy.

For example, in some implementations, the optical signal may be utilized in order to generate and provide broad phonetic class information (e.g., detection of voiced segment, detection of consonant segment, detection of fricative segment, detection of non-speech), and such additional data or information may be utilized by the SR/ASR processor or engine (e.g., which may operate based on acoustic signals captured by acoustic microphone(s)). Such information that is based on the optical signal, may be incorporated or added to the search space of SR/ASR, by restricting possible modes at particular segments. In a demonstrative example, the optical (laser-based) microphone may provide a high-confidence indication that a particular segment is Voiced; and based on such indicator, only voiced Hidden Markov Models (HMMs) or other recognition models or algorithms may be tested or may be selectively applied to such segment.

In some embodiments of the present invention, the methods and elements that are described herein, and/or the other components or modules that are described herein, may be utilized to achieve one or more other (or additional) goals or results or benefits, for example: source separation; speaker identification; overcoming or reducing non-desired reverberation; performing BSS (or improving or enhancing acoustic signals) when one source in known (e.g., not necessarily an optical or laser-based source); performing emotions recognition or mood recognition based on optical (or acoustic-optical or acousto-optical or audio-optical or audio-visual) signal(s); and/or other suitable purposes.

The terms “laser” or “laser transmitter” as used herein may comprise or may be, for example, a stand-alone laser transmitter, a laser transmitter unit, a laser generator, a component able to generate and/or transmit a laser beam or a laser ray, a laser drive, a laser driver, a laser transmitter associated with a modulator, a combination of laser transmitter with modulator, a combination of laser driver or laser drive with modulator, or other suitable component able to generate and/or transmit a laser beam.

The term “acoustic microphone” as used herein, may comprise one or more acoustic microphone(s) and/or acoustic sensor(s); or a matrix or array or set or group or batch or arrangement of multiple such acoustic microphones and/or acoustic sensors; or one or more sensors or devices or units or transducers or converters (e.g., an acoustic-to-electric transducer or converter) able to convert sound into an electrical signal; a microphone or transducer that utilizes electromagnetic induction (e.g., a dynamic microphone) and/or capacitance change (e.g., a condenser microphone) and/or piezoelectricity (e.g., a piezoelectric microphones) in order to produce an electrical signal from air pressure variations; a microphone that may optionally be connected to, or may be associated with or may comprise also, a pre-amplifier or an amplifier; a carbon microphone; a carbon button microphone; a button microphone; a ribbon microphone; an electret condenser microphone; a capacitor microphone; a magneto-dynamic microphone; a dynamic microphone; an electrostatic microphone; a Radio Frequency (RF) condenser microphone; a crystal microphone; a piezo microphone or piezoelectric microphone; and/or other suitable types of audio microphones, acoustic microphones and/or sound-capturing microphones.

The term “laser microphone” as used herein, may comprise, for example: one or more laser microphone(s) or sensor(s); one or more laser-based microphone(s) or sensor(s); one or more optical microphone(s) or sensor(s); one or more microphone(s) or sensor(s) that utilize coherent electromagnetic waves; one or more optical sensor(s) or laser-based sensor(s) that utilize vibrometry, or that comprise or utilize a vibrometer; one or more optical sensor(s) and/or laser-based sensor(s) that comprise a self-mix module, or that utilize self-mixing interferometry measurement technique (or feedback interferometry, or induced-modulation interferometry, or backscatter modulation interferometry), in which a laser beam is reflected from an object, back into the laser, and the reflected light interferes with the light generated inside the laser, and this causes changes in the optical and/or electrical properties of the laser, and information about the target object and the laser itself may be obtained by analyzing these changes.

The terms “vibrating” or “vibrations” or “vibrate” or similar terms, as used herein, refer and include also any other suitable type of motion, and may not necessarily require vibration or resonance per se; and may include, for example, any suitable type of motion, movement, shifting, drifting, slanting, horizontal movement, vertical movement, diagonal movement, one-dimensional movement, two-dimensional movement, three-dimensional movement, or the like.

In some embodiments of the present invention, which may optionally utilize a laser microphone, only “safe” laser beams or sources may be used; for example, laser beam(s) or source(s) that are known to be non-damaging to human body and/or to human eyes, or laser beam(s) or source(s) that are known to be non-damaging even if accidently hitting human eyes for a short period of time. Some embodiments may utilize, for example, Eye-Safe laser, infra-red laser, infra-red optical signal(s), low-strength laser, and/or other suitable type(s) of optical signals, optical beam(s), laser beam(s), infra-red beam(s), or the like. It would be appreciated by persons of ordinary skill in the art, that one or more suitable types of laser beam(s) or laser source(s) may be selected and utilized, in order to safely and efficiently implement the system and method of the present invention. In some embodiments, optionally, a human speaker or a human user may be requested to wear sunglasses or protective eye-gear or protective goggles, in order to provide additional safety to the eyes of the human user which may occasionally be “hit” by such generally-safe laser beam, as an additional precaution.

In some embodiments which may utilize a laser microphone or optical microphone, such optical microphone (or optical sensor) and/or its components may be implemented as (or may comprise) a Self-Mix module; for example, utilizing a self-mixing interferometry measurement technique (or feedback interferometry, or induced-modulation interferometry, or backscatter modulation interferometry), in which a laser beam is reflected from an object, back into the laser. The reflected light interferes with the light generated inside the laser, and this causes changes in the optical and/or electrical properties of the laser. Information about the target object and the laser itself may be obtained by analyzing these changes. In some embodiments, the optical microphone or laser microphone operates to remotely detect or measure or estimate vibrations of the skin (or the surface) of a face-point or a face-region or a face-area of the human speaker (e.g., mouth, mouth-area, lips, lips-area, cheek, nose, chin, neck, throat, ear); and/or to remotely detect or measure or estimate the direct changes in skin vibrations; rather than trying to measure indirectly an effect of spoken speech on a vapor that is exhaled by the mouth of the speaker, and rather than trying to measure indirectly an effect of spoken speech on the humidity or relative humidity or gas components or liquid components that may be produced by the mouth due to spoken speech.

The present invention may be utilized in, or with, or in conjunction with, a variety of devices or systems that may benefit from noise reduction and/or speech enhancement; for example, a smartphone, a cellular phone, a cordless phone, a video conference system or device, a tele-conference system or device, an audio/video camera, a web-camera or web-cam, a landline telephony system, a cellular telephone system, a voice-messaging system, a Voice-over-IP system or network or device, a vehicle, a vehicular dashboard, a vehicular audio system or microphone, a navigation device or system, a vehicular navigation device or system, a mapping or route-guidance device or system, a vehicular route-guidance or device or system, a dictation system or device, Speech Recognition (SR) device or module or system, Automatic Speech Recognition (ASR) module or device or system, a speech-to-text converter or conversion system or device, a laptop computer, a desktop computer, a notebook computer, a tablet, a phone-tablet or “phablet” device, a gaming device, a gaming console, a wearable device, a smart-watch, a Virtual Reality (VR) device or helmet or glasses or headgear, an Augmented Reality (AR) device or helmet or glasses or headgear, an Internet of Things (IoT) device or appliance, an Internet-connected device or appliance, a wireless-connected device or appliance, a device or system or module that utilizes speech-based commands or audio commands, a device or system that captures and/or records and/or processes and/or analyzes audio signals and/or speech and/or acoustic signals, and/or other suitable systems and devices.

Some embodiments of the present invention may provide or may comprise a laser-based device or apparatus or system, a laser-based microphone or sensor, a laser microphone or sensor, an optical microphone or sensor, a hybrid acoustic-optical sensor or microphone, a combined acoustic-optical sensor or microphone, and/or a system that comprises or utilizes one or more of the above.

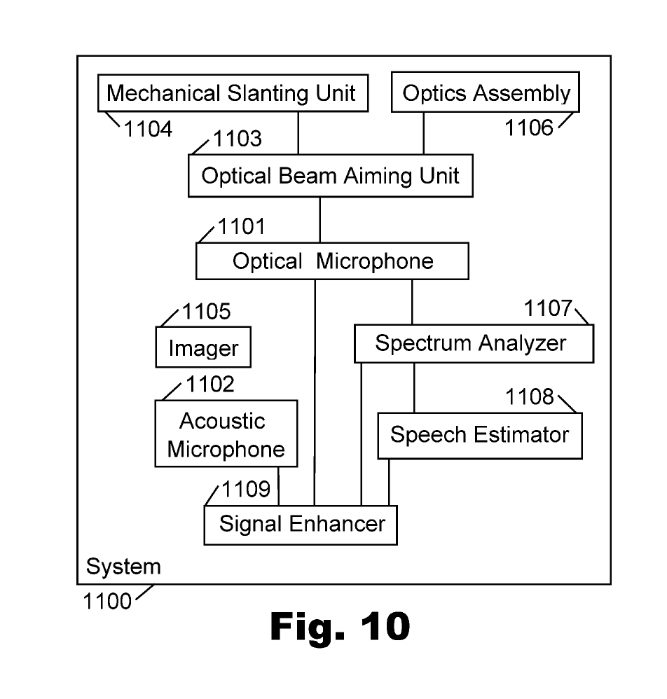

Reference is made to FIG. 10, which is a schematic block-diagram illustration of a system 1100, in accordance with some demonstrative embodiments of the present invention.

System 1100 may comprise, for example, an optical microphone 1101 able to transmit an optical beam (e.g., a laser beam) towards a target (e.g., a face of a human speaker), and able to capture and analyze the optical feedback that is reflected from the target, particularly from vibrating regions or vibrating face-regions or face-portions of the human speaker. The optical microphone 1101 may be or may comprise or may utilize a Self-Mix (SM) chamber or unit, an interferometry chamber or unit, an interferometer, a vibrometer, a targeted vibrometer, or other suitable component, able to analyze the spectrum of the received optical signal with reference to the transmitted optical beam, and able to remotely estimate the audio or speech or utterances generated by the target (e.g., the human speaker).

Optionally, system 1100 may comprise an acoustic microphone 1102 or an audio microphone, which may capture audio. Optionally, the analysis results of the optical feedback may be utilized in order to improve or enhance or filter the captured audio signal; and/or to reduce or cancel noise(s) from the captured audio signal. Optionally, system 1100 may be implemented as a hybrid acoustic-and-optical sensor, or as a hybrid acoustic-and-optical sensor. In other embodiments, system 1100 need not necessarily comprise an acoustic microphone. In yet other embodiments, system 1100 may comprise optical microphone 1102 and may not comprise any acoustic microphones, but may operate in conjunction with an external or a remote acoustic microphone.

System 1100 may further comprise an optical beam aiming unit 1103 (or tilting unit, or slanting unit, or positioning unit, or targeting unit, or directing unit), for example, implemented as a laser beam directing unit or aiming unit or other unit or module able to direct a transmitted optical beam (e.g., a transmitted laser beam) towards the target, and/or able to fine-tune or modify the direction of such optical beam or laser beam. The directing or alignment of the optical beam or laser beam, towards the target, may be performed or achieved by using one or more suitable mechanisms.

In a first example, the optical microphone 1101 may be fixedly mounted or attached or located at a first location or point (e.g., on a vehicular dashboard; on a frame of a screen of a laptop computer), and may generally point or be directed towards an estimated location or a general location of a human speaker that typically utilizes such device (e.g., aiming or targeting an estimated general location of a head of a driver in a vehicle; or aiming or targeting an estimated general location of a head of a laptop computer user); based on a fixed or pre-mounted angular slanting or positioning (e.g., performed by a maker of the vehicular dashboard or vehicle, or by the maker of the laptop computer).

In a second example, the optical microphone may be mounted on a wall of a lecture hall; and may be fixedly pointing or aiming its laser beam or its optical beam towards a general location of a stage or a podium in that lecture hall, in order to target a human speaker who is a lecturer.

In a third example, a motor or engine or robotic arm or other mechanical slanting unit 1104 may be used, in order to align or slant or tilt the direction of the optical beam or laser beam of the optical microphone, towards an actual or an estimated location of a human speaker; optionally via a control interface that allows an administrator to command the movement or the slanting of the optical microphone towards a desired target (e.g., similar to the manner in which an optical camera or an imager or a video-recording device may be moved or tilted via a control interface, a pan-tilt-zoom (PTZ) interface, a robotic arm, or the like).

In a fourth example, an imager 1105 or camera may be used in order to capture images or video of the surrounding of the optical microphone; and a face-recognition module or image-recognition module or a face-identifying module or other Computer Vision algorithm or module may be used in order to analyze the captured images or video and to determine the location of a human speaker (or a particular, desired, human speaker), and to cause the slanting or aiming or targeting or re-aligning of the optical beam to aim towards the identified human speaker. In a fifth example, a human speaker may be requested to wear or to carry a particular tag or token or article or object, having a pre-defined shape or color or pattern which is not typically found at random (e.g., tag or a button showing a green triangle within a yellow square); and an imager or camera may scan an area or a surrounding of system 1100, may analyze the images or video to detect or to find the pre-defined tag, and may aim the optical microphone towards the tag, or towards a pre-defined or estimated offset distance from that tag (e.g., a predefined K degrees of slanting upwardly or vertically relative to the detected tag, if the human speaker is instructed to carry the tag or to wear the tag on his jacket pocket).

In a sixth example, an optics assembly 1106 or optics arrangement (e.g., one or more minors, flat minors, concave minors, convex minors, lenses, prisms, beam-splitters, focusing elements, diffracting elements, diffractive elements, condensing elements, and/or other optics elements or optical elements) may be utilized in order to direct or aim the optical beam or laser beam towards a known or estimated or general location of a target or a speaker or a human face. The optics assembly may be fixedly mounted in advance (e.g., within a vehicle, in order to aim or target a vehicular optical sensor towards a general-location of a driver face), or may be dynamically adjusted or moved or tilted or slanted based on real-time information regarding the actual or estimated location of the speaker or his head (e.g., determined by using an imager, or determined by finding a Signal to Noise Ratio (SNR) value that is greater than a threshold value).

In a seventh example, the optical microphone may move or may “scan” a target area (e.g., by being moved or slanted via the mechanical slanting unit 1104); and may remain at, or may go-back to, a particular direction in which the Signal to Noise Ratio (SNR) value was the maximal, or optimal, or greater than a threshold value.

In an eighth example, particularly if the human speaker is moving on a stage or moving in a room, or moves his face to different directions, the human speaker may be requested or required to stand at a particular spot or location in order to enable the system to efficiently work (e.g., similarly to the manner in which a singer or a performer is required to stand in proximity to a wired acoustic microphone which is mounted on a microphone stand); and/or the human speaker may be requested or required to look to a particular direction or to move his face to a particular direction (e.g., to look directly towards the optical microphone) in order for the system to efficiently operate (e.g., similar to the manner in which a singer or a performer may be requested to look at a camera or a video-recorder, or to put his mouth in close proximity to an acoustic microphone that he holds).

Other suitable mechanisms may be used to achieve or to fine-tune aiming, targeting and/or aligning of the optical beam with the desired target.

It is clarified that the optical microphone and/or the system of the present invention, need not be continuously aligned with the target or the human speaker, and need not necessarily “hit” the speaker continuously with laser beam or optical beam. Rather, in some embodiments, the present invention may operate only during time-periods in which the optical beam or laser beam actually “hits” the face of the speaker, or actually causes reflection of optical feedback from vibrating face-regions of the human speaker. In some embodiments, the system may operate or may efficiently operate at least during time period(s) in which the laser beam(s) or the optical signal(s) actually hit (or reach, or touch) the face or the mouth or the mouth-region of a speaker; and not in other time-periods or time-slots. In some embodiments, the system and/or method need not necessarily provide continuous speech enhancement or continuous noise reduction or continuous speech detection; but rather, in some embodiments the speech enhancement and/or noise reduction and/or speech detection may be achieved in those specific time-periods in which the laser beam(s) actually hit the face of the speaker and cause a reflection of optical feedback from vibrating surfaces or face-regions. In some embodiments, the system may operate only during such time periods (e.g., only a few minutes out of an hour; or only a few seconds out of a minute) in which such actual “hit” of the laser beam with the face-region is achieved. In other embodiments, continuous or substantially-continuous noise reduction and/or speech enhancement may be achieved; for example, in a vehicular system in which the laser beam is directed towards the location of the head or the face of the driver.

In accordance with the present invention, the optical microphone 1101 may comprise a self-mix chamber or unit or self-mix interferometer or a targeted vibrometer, and may utilize reflected optical feedback (e.g., reflected feedback of a transmitted laser beam) in order to remotely measure or estimate vibrations of the facial skin or facial-regions head-regions of a human speaker, utilizing a spectrum analyzer 1107 in order to analyze the optical feedback with reference to the transmitted optical feedback, and utilizing a speech estimator unit 1108 to estimate or extract a signal that corresponds to speech or audio that is generated or uttered by that human speaker.

Optionally, system 1100 may comprise a signal enhancer 1109, which may enhance, filter, improve and/or clean the acoustic signal that is captured by acoustic microphone 1102, based on output generated by the optical microphone 1101. For example, system 1100 may dynamically generate and may dynamically apply, to the acoustic signal captured by the acoustic microphone 1102, a digital filter which may be dynamically constructed by taking into account the output of the optical microphone 1101, and/or by taking into account an analysis of the optical feedback or optical signal(s) that are reflected back from the face of the human speaker.

System 1100 may further comprise any, or some, or all, of the components and/or systems that are depicted in any of FIGS. 1-9, and/or that are discussed with reference to FIGS. 1-9 and/or above and/or herein.

The present invention may be utilized in conjunction with one or more types of acoustic samples or data samples, or a voice sample or voice print, which may not necessarily be merely an acoustic recording or raw acoustic sounds, and/or which may not necessarily be a cleaned or digitally-cleaned or filtered or digitally-filtered acoustic recording or acoustic data. For example, the present invention may utilize, or may operate in conjunction with, in addition to or instead of the other samples or data as described above, one or more of the following: (a) the speech signal, or estimated or detected speech signal, as determined by the optical microphone 1101 based on an analysis of the self-mixed optical signals; (b) an acoustic sample as captured by the acoustic microphone 1102, by itself and/or in combination with the speech signal estimated by the optical microphone 1101; (c) an acoustic sample as captured by the acoustic microphone 1102 and as cleaned or digitally-cleaned or filtered or digitally-filtered or otherwise digitally-adjusted or digitally-modified based on the speech signal estimated by the optical microphone 1101; (d) a voice print or speech sample which is acquired and/or produced by utilizing one or more biometric algorithms or sub-modules, such as a Neural Network module or a Hidden Markov Model (HMM) unit, which may utilize both the acoustic signal and the optical signal (e.g., the self-mixed signals of the optical microphone 1101) in order to extract more data and/or more user-specific characteristics from utterances of the human speaker.

Some embodiments of the present invention may comprise an optical microphone or laser microphone or a laser-based microphone, or optical sensor or laser sensor or laser-based sensor, which utilizes multiple lasers or multiple laser beams or multiple laser transmitters, in conjunction with a single laser drive component and/or a single laser receiver component, thereby increasing or improving the efficiency of self-mix techniques or module or chamber (or self-mix interferometry techniques or module or chamber) utilized by such optical or laser-based microphone or sensor.

In some embodiments of the present invention, which may optionally utilize a laser microphone or optical microphone, the laser beam or optical beam may be directed to an estimated general-location of the speaker; or to a pre-defined target area or target region in which a speaker may be located, or in which a speaker is estimated to be located. For example, the laser source may be placed inside a vehicle, and may be targeting the general location at which a head of the driver is typically located. In other embodiments, a system may optionally comprise one or more modules that may, for example, locate or find or detect or track, a face or a mouth or a head of a person (or of a speaker), for example, based on image recognition, based on video analysis or image analysis, based on a pre-defined item or object (e.g., the speaker may wear a particular item, such as a hat or a collar having a particular shape and/or color and/or characteristics), or the like. In some embodiments, the laser source(s) may be static or fixed, and may fixedly point towards a general-location or towards an estimated-location of a speaker. In other embodiments, the laser source(s) may be non-fixed, or may be able to automatically move and/or change their orientation, for example, to track or to aim towards a general-location or an estimated-location or a precise-location of a speaker. In some embodiments, multiple laser source(s) may be used in parallel, and they may be fixed and/or moving.

In some demonstrative embodiments of the present invention, which may optionally utilize a laser microphone or optical microphone, the system and method may efficiently operate at least during time period(s) in which the laser beam(s) or the optical signal(s) actually hit (or reach, or touch) the face or the mouth or the mouth-region of a speaker. In some embodiments, the system and/or method need not necessarily provide continuous speech enhancement or continuous noise reduction; but rather, in some embodiments the speech enhancement and/or noise reduction may be achieved in those time-periods in which the laser beam(s) actually hit the face of the speaker. In other embodiments, continuous or substantially-continuous noise reduction and/or speech enhancement may be achieved; for example, in a vehicular system in which the laser beam is directed towards the location of the head or the face of the driver.

The system(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules. The system(s) of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

Some embodiments of the present invention may comprise, or may utilize, or may be utilized in conjunction with, one or more elements, units, devices, systems and/or methods that are described in U.S. Pat. No. 7,775,113, titled “Sound sources separation and monitoring using directional coherent electromagnetic waves”, which is hereby incorporated by reference in its entirety.

Some embodiments of the present invention may comprise, or may utilize, or may be utilized in conjunction with, one or more elements, units, devices, systems and/or methods that are described in U.S. Pat. No. 8,286,493, titled “Sound sources separation and monitoring using directional coherent electromagnetic waves”, which is hereby incorporated by reference in its entirety.

Some embodiments of the present invention may comprise, or may utilize, or may be utilized in conjunction with, one or more elements, units, devices, systems and/or methods that are described in U.S. Pat. No. 8,949,118, titled “System and method for robust estimation and tracking the fundamental frequency of pseudo periodic signals in the presence of noise”, which is hereby incorporated by reference in its entirety.

Some embodiments of the present invention may comprise, or may utilize, or may be utilized in conjunction with, one or more elements, units, devices, systems and/or methods that are described in U.S. Pat. No. 9,344,811, titled “System and method for detection of speech related acoustic signals by using a laser microphone”, which is hereby incorporated by reference in its entirety.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL, BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

In accordance with some embodiments of the present invention, a system comprises, for example: an acoustic microphone to sense an acoustic signal (A) generated by a human speaker; a laser microphone to transmit a laser beam towards a face of the human speaker, to receive an optical feedback signal reflected from the face of the human speaker, and to generate an optical self-mix signal by self-mixing interferometry; a Speech Recognition processor to perform speech recognition based on both (i) the acoustic signal sensed by the acoustic microphone, and (ii) the self-mix signal produced by the laser microphone.

In some embodiments, the Speech Recognition processor comprises: a Speech Recognition training unit to perform training of speech recognition based exclusively on said self-mix signal produced by the laser microphone.

In some embodiments, the Speech Recognition processor comprises: a Speech Recognition training unit to perform training of speech recognition based exclusively on said self-mix signal produced by the laser microphone; a Speech Recognition recognizing module to perform recognition of utterances based exclusively on a fresh self-mix signal produced by the laser microphone.

In some embodiments, the Speech Recognition processor comprises: a Speech Recognition training unit to perform training of speech recognition based exclusively on said self-mix signal produced by the laser microphone; a Speech Recognition recognizing module to perform recognition of utterances based on both: (I) a fresh self-mix signal produced by the laser microphone, and (II) a fresh acoustic signal sensed by the acoustic microphone.

In some embodiments, the Speech Recognition processor comprises: a Speech Recognition training unit to perform training of speech recognition based exclusively on said self-mix signal produced by the laser microphone; a signal enhancing module to enhance acoustic signals, that are sensed by the acoustic microphone, based on said self-mix signal produced by the laser microphone, and to produce an enhanced acoustic signal; a Speech Recognition recognizing module to perform recognition of utterances based on said enhanced acoustic signal.

In some embodiments, the Speech Recognition processor comprises: a Speech Recognition training unit to perform training of speech recognition based exclusively on said self-mix signal produced by the laser microphone; a signal enhancing module, (I) to construct a digital filter based on said self-mix signal, and (II) to apply said digital filter to acoustic signals sensed by the acoustic microphone, and (III) to produce a digitally-filtered acoustic signal; a Speech Recognition recognizing module to perform recognition of utterances based on said digitally-filtered acoustic signal.

In some embodiments, the Speech Recognition processor comprises: a Speech Recognition training unit to perform training of speech recognition based on both: (I) said self-mix signal produced by the laser microphone, and (II) said acoustic signal sensed by the acoustic microphone.

In some embodiments, the Speech Recognition processor comprises: a Speech Recognition training unit to perform training of speech recognition based on both: (I) said self-mix signal produced by the laser microphone, and (II) said acoustic signal sensed by the acoustic microphone; a Speech Recognition recognizing module to perform recognition of utterances based exclusively on a fresh self-mix signal produced by the laser microphone.

In some embodiments, the Speech Recognition processor comprises: a Speech Recognition training unit to perform training of speech recognition based on both: (I) said self-mix signal produced by the laser microphone, and (II) said acoustic signal sensed by the acoustic microphone; a Speech Recognition recognizing module to perform recognition of utterances based on both: (I) a fresh self-mix signal produced by the laser microphone, and (II) a fresh acoustic signal sensed by the acoustic microphone.

In some embodiments, the Speech Recognition processor comprises: a Speech Recognition training unit to perform training of speech recognition based on both: (I) said self-mix signal produced by the laser microphone, and (II) said acoustic signal sensed by the acoustic microphone; a signal enhancing module to enhance acoustic signals, that are sensed by the acoustic microphone, based on said self-mix signal produced by the laser microphone, and to produce an enhanced acoustic signal; a Speech Recognition recognizing module to perform recognition of utterances based on said enhanced acoustic signal.

In some embodiments, the Speech Recognition processor comprises: a Speech Recognition training unit to perform training of speech recognition based on both: (I) said self-mix signal produced by the laser microphone, and (II) said acoustic signal sensed by the acoustic microphone; a signal enhancing module, (I) to construct a digital filter based on said self-mix signal, and (II) to apply said digital filter to acoustic signals sensed by the acoustic microphone, and (III) to produce a digitally-filtered acoustic signal; a Speech Recognition recognizing module to perform recognition of utterances based on said digitally-filtered acoustic signal.

In some embodiments, the Speech Recognition processor comprises: a signal enhancing module to enhance acoustic signals, that are sensed by the acoustic microphone, based on said self-mix signal produced by the laser microphone, and to produce an enhanced acoustic signal; a Speech Recognition training unit to perform training of speech recognition based exclusively on said enhanced acoustic signal.

In some embodiments, the Speech Recognition processor comprises: a signal enhancing module to enhance acoustic signals, that are sensed by the acoustic microphone, based on said self-mix signal produced by the laser microphone, and to produce an enhanced acoustic signal; a Speech Recognition training unit to perform training of speech recognition based at least on said enhanced acoustic signal.

In some embodiments, the Speech Recognition processor comprises: a signal enhancing module to enhance acoustic signals, that are sensed by the acoustic microphone, based on said self-mix signal produced by the laser microphone, and to produce an enhanced acoustic signal; a Speech Recognition training unit to perform training of speech recognition based on both: (I) said enhanced acoustic signal, and (II) said self-mix signal produced by the laser microphone.

In some embodiments, the Speech Recognition processor comprises: a signal enhancing module to enhance acoustic signals, that are sensed by the acoustic microphone, based on said self-mix signal produced by the laser microphone, and to produce an enhanced acoustic signal; a Speech Recognition training unit to perform training of speech recognition based exclusively on said enhanced acoustic signal; a Speech Recognition recognizing module to perform recognition of utterances based on a fresh acoustic signal that is sensed by the acoustic microphone and is then enhanced by the signal enhancing module based on said self-mix signal produced by the laser microphone.

In some embodiments, the Speech Recognition processor comprises: a signal enhancing module to enhance acoustic signals, that are sensed by the acoustic microphone, based on said self-mix signal produced by the laser microphone, and to produce an enhanced acoustic signal; a Speech Recognition training unit to perform training of speech recognition based exclusively on said enhanced acoustic signal.

In some embodiments, the Speech Recognition processor comprises: a signal enhancing module, (I) to construct a digital filter based on said self-mix signal, and (II) to apply said digital filter to acoustic signals sensed by the acoustic microphone, and (III) to produce a digitally-filtered acoustic signal; a Speech Recognition training unit to perform training of speech recognition based exclusively on said digitally-filtered acoustic signal.

In some embodiments, the Speech Recognition processor comprises: a signal enhancing module, (I) to construct a digital filter based on said self-mix signal, and (II) to apply said digital filter to acoustic signals sensed by the acoustic microphone, and (III) to produce a digitally-filtered acoustic signal; a Speech Recognition training unit to perform training of speech recognition based at least on said digitally-filtered acoustic signal.

In some embodiments, the Speech Recognition processor comprises: a signal enhancing module, (I) to construct a digital filter based on said self-mix signal, and (II) to apply said digital filter to acoustic signals sensed by the acoustic microphone, and (III) to produce a digitally-filtered acoustic signal; a Speech Recognition training unit to perform training of speech recognition based on both: (I) said digitally-filtered acoustic signal, and (II) said self-mix signal produced by the laser microphone.

In some embodiments, the Speech Recognition processor comprises: a signal enhancing module, (I) to construct a digital filter based on said self-mix signal, and (II) to apply said digital filter to acoustic signals sensed by the acoustic microphone, and (III) to produce a digitally-filtered acoustic signal; a Speech Recognition training unit to perform training of speech recognition based exclusively on said digitally-filtered acoustic signal; a Speech Recognition recognizing module to perform recognition of utterances based on a digitally-filtered acoustic signal that is sensed by the acoustic microphone and is then digitally-filtered by the signal enhancing module based on said self-mix signal produced by the laser microphone.

In some embodiments, the Speech Recognition processor comprises: a signal enhancing module, (I) to construct a digital filter based on said self-mix signal, and (II) to apply said digital filter to acoustic signals sensed by the acoustic microphone, and (III) to produce a digitally-filtered acoustic signal; a Speech Recognition training unit to perform training of speech recognition based exclusively on said digitally-filtered acoustic signal; a Speech Recognition recognizing module to perform recognition of utterances based on both: (I) a fresh self-mix signal produced by the laser microphone, and (II) a digitally-filtered acoustic signal that is sensed by the acoustic microphone and is then digitally-filtered by the signal enhancing module based on said self-mix signal produced by the laser microphone.

In some embodiments, the Speech Recognition processor comprises: a training unit that performs a training process that is based on the self-mix signal produced by the laser microphone; a recognition unit that performs recognition of utterances based on a fresh self-mix signal produced by the laser microphone in response to fresh utterances that are uttered for recognition.

In some embodiments, the Speech Recognition processor comprises: a training unit that performs a training process that is based on a distorted acoustic signal that is produced by correlating the acoustic signal with the self-mix signal produced by the laser microphone; a recognition unit that performs recognition of utterances based on a distorted acoustic signal that is produced by correlating fresh acoustic signal with a fresh self-mix signal produced by the laser microphone.

In some embodiments, the Speech Recognition processor comprises: a signal enhancing module to analyze a relation between (I) low frequencies in the self-mix signal produced by the laser microphone, and (II) all frequencies of the acoustic signal that are utilized by an utterance recognition unit of said Speech Recognition processor; wherein the signal enhancing unit is to construct, based on said relation and based on said self-mix signal, a digital filter that operates on all frequencies of the acoustic signal that are utilized by the utterance recognition unit of said Speech Recognition processor.

In some embodiments, the Speech Recognition processor comprises: a training unit to perform Speech Recognition training that utilizes at least said self-mix signal produced by the laser microphone; an utterance recognition unit to perform recognition of utterances, based on a set of speech recognition rules that are constructed by said training unit, and based at least on a fresh acoustic signal sensed by the acoustic microphone.

In some embodiments, the Speech Recognition processor comprises: a training unit to perform Speech Recognition training that utilizes at least said self-mix signal produced by the laser microphone; an utterance recognition unit to perform recognition of utterances, based on a set of speech recognition rules that are constructed by said training unit, and further based on both: (I) a fresh acoustic signal sensed by the acoustic microphone, and (II) a fresh self-mix signal produced by the laser microphone.

In some embodiments, the Speech Recognition processor comprises: a training unit to perform Speech Recognition training that utilizes at least said self-mix signal produced by the laser microphone; a signal enhancing module to produce a fresh digitally-filtered acoustic signal, by (I) constructing a digital filter based on said self-mix signal, and (II) applying said digital filter to fresh acoustic signals sensed by the acoustic microphone; an utterance recognition unit to perform recognition of utterances, based on a set of speech recognition rules that are constructed by said training unit, and further based on said fresh digitally-filtered acoustic signal.

In some embodiments, the Speech Recognition processor comprises: a training unit to perform Speech Recognition training that utilizes at least said self-mix signal produced by the laser microphone; an utterance recognition unit to perform recognition of utterances, based on a set of speech recognition rules that are constructed by said training unit, wherein the training unit is configured to restrict a search-space of Speech Recognition rules, that is searched by said utterance recognition unit, based on analysis of said self-mix signal produced by the laser microphone.

In some embodiments, the Speech Recognition processor comprises: a training unit to perform Speech Recognition training that utilizes at least said self-mix signal produced by the laser microphone; an utterance recognition unit to perform recognition of utterances, based on a set of speech recognition rules that are constructed by said training unit, wherein the utterance recognition unit is to generate a high-confidence indicator that a particular sensed audio segment contains human voice, based on analysis of a self-mix signal that corresponds in time to said particular sensed audio segment.

In some embodiments, the system is a hybrid acoustic-and-optical sensor.

In some embodiments, the system is a hybrid acoustic-and-optical sensor that is comprised in an apparatus selected from the group consisting of: a laptop computer, a smartphone, a tablet, a portable electronic device, a vehicular audio system.

The present invention may comprise devices, systems, and methods of enhanced automatic speech recognition. An acoustic microphone senses or captures acoustic signals that are uttered by a human speaker. An optical microphone or laser microphone transmits a laser beam aimed towards the face of the human speaker; receives a reflected optical feedback signal; and produces an optical self-mix signal by self-mixing interferometry. The self-mix signal is used by a training unit of a speech recognition processor. Optionally, the self-mix signal is used by an utterance recognition unit of the speech recognition processor. Optionally, the self-mix signal is utilized for enhancing the acoustic signals, or for constructing a digital filter that is applied to the acoustic signal; and the enhanced acoustic signal, or the filtered acoustic signal, is used by the training unit or by the a recognition unit of the speech recognition processor.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

1. A system comprising:
an acoustic microphone to sense an acoustic signal (A) generated by a human speaker;
a laser microphone to transmit a laser beam towards a face of the human speaker, to receive an optical feedback signal reflected from the face of the human speaker, and to generate an optical self-mix signal by self-mixing interferometry;
a Speech Recognition processor to perform speech recognition based on both (i) the acoustic signal sensed by the acoustic microphone, and (ii) the self-mix signal produced by the laser microphone.

2. The system of claim 1, wherein the Speech Recognition processor comprises:
a Speech Recognition training unit to perform training of speech recognition based exclusively on said self-mix signal produced by the laser microphone.

3. The system of claim 1, wherein the Speech Recognition processor comprises:
a Speech Recognition training unit to perform training of speech recognition based exclusively on said self-mix signal produced by the laser microphone;
a Speech Recognition recognizing module to perform recognition of utterances based exclusively on a fresh self-mix signal produced by the laser microphone.

4. The system of claim 1, wherein the Speech Recognition processor comprises:
a Speech Recognition training unit to perform training of speech recognition based exclusively on said self-mix signal produced by the laser microphone;
a Speech Recognition recognizing module to perform recognition of utterances based on both: (I) a fresh self-mix signal produced by the laser microphone, and (II) a fresh acoustic signal sensed by the acoustic microphone.

5. The system of claim 1, wherein the Speech Recognition processor comprises:
a Speech Recognition training unit to perform training of speech recognition based exclusively on said self-mix signal produced by the laser microphone;
a signal enhancing module to enhance acoustic signals, that are sensed by the acoustic microphone, based on said self-mix signal produced by the laser microphone, and to produce an enhanced acoustic signal;
a Speech Recognition recognizing module to perform recognition of utterances based on said enhanced acoustic signal.

6. The system of claim 1, wherein the Speech Recognition processor comprises:
a Speech Recognition training unit to perform training of speech recognition based exclusively on said self-mix signal produced by the laser microphone;
a signal enhancing module, (I) to construct a digital filter based on said self-mix signal, and (II) to apply said digital filter to acoustic signals sensed by the acoustic microphone, and (III) to produce a digitally-filtered acoustic signal;
a Speech Recognition recognizing module to perform recognition of utterances based on said digitally-filtered acoustic signal.

7. The system of claim 1, wherein the Speech Recognition processor comprises:
a Speech Recognition training unit to perform training of speech recognition based on both: (I) said self-mix signal produced by the laser microphone, and (II) said acoustic signal sensed by the acoustic microphone.

8. The system of claim 1, wherein the Speech Recognition processor comprises:
a Speech Recognition training unit to perform training of speech recognition based on both: (I) said self-mix signal produced by the laser microphone, and (II) said acoustic signal sensed by the acoustic microphone;
a Speech Recognition recognizing module to perform recognition of utterances based exclusively on a fresh self-mix signal produced by the laser microphone.

9. The system of claim 1, wherein the Speech Recognition processor comprises:
a Speech Recognition training unit to perform training of speech recognition based on both: (I) said self-mix signal produced by the laser microphone, and (II) said acoustic signal sensed by the acoustic microphone;
a Speech Recognition recognizing module to perform recognition of utterances based on both: (I) a fresh self-mix signal produced by the laser microphone, and (II) a fresh acoustic signal sensed by the acoustic microphone.

10. The system of claim 1, wherein the Speech Recognition processor comprises:
a Speech Recognition training unit to perform training of speech recognition based on both: (I) said self-mix signal produced by the laser microphone, and (II) said acoustic signal sensed by the acoustic microphone;
a signal enhancing module to enhance acoustic signals, that are sensed by the acoustic microphone, based on said self-mix signal produced by the laser microphone, and to produce an enhanced acoustic signal;
a Speech Recognition recognizing module to perform recognition of utterances based on said enhanced acoustic signal.

11. The system of claim 1, wherein the Speech Recognition processor comprises:
a Speech Recognition training unit to perform training of speech recognition based on both: (I) said self-mix signal produced by the laser microphone, and (II) said acoustic signal sensed by the acoustic microphone;
a signal enhancing module, (I) to construct a digital filter based on said self-mix signal, and (II) to apply said digital filter to acoustic signals sensed by the acoustic microphone, and (III) to produce a digitally-filtered acoustic signal;
a Speech Recognition recognizing module to perform recognition of utterances based on said digitally-filtered acoustic signal.

12. The system of claim 1, wherein the Speech Recognition processor comprises:
a signal enhancing module to enhance acoustic signals, that are sensed by the acoustic microphone, based on said self-mix signal produced by the laser microphone, and to produce an enhanced acoustic signal;
a Speech Recognition training unit to perform training of speech recognition based exclusively on said enhanced acoustic signal.

13. The system of claim 1, wherein the Speech Recognition processor comprises:
a signal enhancing module to enhance acoustic signals, that are sensed by the acoustic microphone, based on said self-mix signal produced by the laser microphone, and to produce an enhanced acoustic signal;
a Speech Recognition training unit to perform training of speech recognition based at least on said enhanced acoustic signal.

14. The system of claim 1, wherein the Speech Recognition processor comprises:
a signal enhancing module to enhance acoustic signals, that are sensed by the acoustic microphone, based on said self-mix signal produced by the laser microphone, and to produce an enhanced acoustic signal;
a Speech Recognition training unit to perform training of speech recognition based on both: (I) said enhanced acoustic signal, and (II) said self-mix signal produced by the laser microphone.

15. The system of claim 1, wherein the Speech Recognition processor comprises:
a signal enhancing module to enhance acoustic signals, that are sensed by the acoustic microphone, based on said self-mix signal produced by the laser microphone, and to produce an enhanced acoustic signal;
a Speech Recognition training unit to perform training of speech recognition based exclusively on said enhanced acoustic signal;
a Speech Recognition recognizing module to perform recognition of utterances based on a fresh acoustic signal that is sensed by the acoustic microphone and is then enhanced by the signal enhancing module based on said self-mix signal produced by the laser microphone.

16. The system of claim 1, wherein the Speech Recognition processor comprises:
a signal enhancing module to enhance acoustic signals, that are sensed by the acoustic microphone, based on said self-mix signal produced by the laser microphone, and to produce an enhanced acoustic signal;
a Speech Recognition training unit to perform training of speech recognition based exclusively on said enhanced acoustic signal.

17. The system of claim 1, wherein the Speech Recognition processor comprises:
a signal enhancing module, (I) to construct a digital filter based on said self-mix signal, and (II) to apply said digital filter to acoustic signals sensed by the acoustic microphone, and (III) to produce a digitally-filtered acoustic signal;
a Speech Recognition training unit to perform training of speech recognition based exclusively on said digitally-filtered acoustic signal.

18. The system of claim 1, wherein the Speech Recognition processor comprises:
a signal enhancing module, (I) to construct a digital filter based on said self-mix signal, and (II) to apply said digital filter to acoustic signals sensed by the acoustic microphone, and (III) to produce a digitally-filtered acoustic signal;
a Speech Recognition training unit to perform training of speech recognition based at least on said digitally-filtered acoustic signal.

19. The system of claim 1, wherein the Speech Recognition processor comprises:
a signal enhancing module, (I) to construct a digital filter based on said self-mix signal, and (II) to apply said digital filter to acoustic signals sensed by the acoustic microphone, and (III) to produce a digitally-filtered acoustic signal;
a Speech Recognition training unit to perform training of speech recognition based on both: (I) said digitally-filtered acoustic signal, and (II) said self-mix signal produced by the laser microphone.

20. The system of claim 1, wherein the Speech Recognition processor comprises:
a signal enhancing module, (I) to construct a digital filter based on said self-mix signal, and (II) to apply said digital filter to acoustic signals sensed by the acoustic microphone, and (III) to produce a digitally-filtered acoustic signal;
a Speech Recognition training unit to perform training of speech recognition based exclusively on said digitally-filtered acoustic signal;
a Speech Recognition recognizing module to perform recognition of utterances based on a digitally-filtered acoustic signal that is sensed by the acoustic microphone and is then digitally-filtered by the signal enhancing module based on said self-mix signal produced by the laser microphone.

21. The system of claim 1, wherein the Speech Recognition processor comprises:
a signal enhancing module, (I) to construct a digital filter based on said self-mix signal, and (II) to apply said digital filter to acoustic signals sensed by the acoustic microphone, and (III) to produce a digitally-filtered acoustic signal;
a Speech Recognition training unit to perform training of speech recognition based exclusively on said digitally-filtered acoustic signal;
a Speech Recognition recognizing module to perform recognition of utterances based on both: (I) a fresh self-mix signal produced by the laser microphone, and (II) a digitally-filtered acoustic signal that is sensed by the acoustic microphone and is then digitally-filtered by the signal enhancing module based on said self-mix signal produced by the laser microphone.

22. The system of claim 1, wherein the Speech Recognition processor comprises:
a training unit that performs a training process that is based on the self-mix signal produced by the laser microphone;
a recognition unit that performs recognition of utterances based on a fresh self-mix signal produced by the laser microphone in response to fresh utterances that are uttered for recognition.

23. The system of claim 1, wherein the Speech Recognition processor comprises:
a training unit that performs a training process that is based on a distorted acoustic signal that is produced by correlating the acoustic signal with the self-mix signal produced by the laser microphone.
a recognition unit that performs recognition of utterances based on a distorted acoustic signal that is produced by correlating fresh acoustic signal with a fresh self-mix signal produced by the laser microphone.

24. The system of claim 1, wherein the Speech Recognition processor comprises:
a signal enhancing module to analyze a relation between (I) low frequencies in the self-mix signal produced by the laser microphone, and (II) all frequencies of the acoustic signal that are utilized by an utterance recognition unit of said Speech Recognition processor;
wherein the signal enhancing unit is to construct, based on said relation and based on said self-mix signal, a digital filter that operates on all frequencies of the acoustic signal that are utilized by the utterance recognition unit of said Speech Recognition processor.

25. The system of claim 1, wherein the Speech Recognition processor comprises:
a training unit to perform Speech Recognition training that utilizes at least said self-mix signal produced by the laser microphone;
an utterance recognition unit to perform recognition of utterances, based on a set of speech recognition rules that are constructed by said training unit, and based at least on a fresh acoustic signal sensed by the acoustic microphone.

26. The system of claim 1, wherein the Speech Recognition processor comprises:
a training unit to perform Speech Recognition training that utilizes at least said self-mix signal produced by the laser microphone;
an utterance recognition unit to perform recognition of utterances, based on a set of speech recognition rules that are constructed by said training unit, and further based on both: (I) a fresh acoustic signal sensed by the acoustic microphone, and (II) a fresh self-mix signal produced by the laser microphone.

27. The system of claim 1, wherein the Speech Recognition processor comprises:
a training unit to perform Speech Recognition training that utilizes at least said self-mix signal produced by the laser microphone;
a signal enhancing module to produce a fresh digitally-filtered acoustic signal, by (I) constructing a digital filter based on said self-mix signal, and (II) applying said digital filter to fresh acoustic signals sensed by the acoustic microphone;
an utterance recognition unit to perform recognition of utterances, based on a set of speech recognition rules that are constructed by said training unit, and further based on said fresh digitally-filtered acoustic signal.

28. The system of claim 1, wherein the Speech Recognition processor comprises:
a training unit to perform Speech Recognition training that utilizes at least said self-mix signal produced by the laser microphone;
an utterance recognition unit to perform recognition of utterances, based on a set of speech recognition rules that are constructed by said training unit,
wherein the training unit is configured to restrict a search-space of Speech Recognition rules, that is searched by said utterance recognition unit, based on analysis of said self-mix signal produced by the laser microphone.

29. The system of claim 1, wherein the Speech Recognition processor comprises:
a training unit to perform Speech Recognition training that utilizes at least said self-mix signal produced by the laser microphone;
an utterance recognition unit to perform recognition of utterances, based on a set of speech recognition rules that are constructed by said training unit,
wherein the utterance recognition unit is to generate a high-confidence indicator that a particular sensed audio segment contains human voice, based on analysis of a self-mix signal that corresponds in time to said particular sensed audio segment.

30. The system of claim 1, wherein the system is a hybrid acoustic-and-optical sensor.

31. The system of claim 1, wherein the system is a hybrid acoustic-and-optical sensor that is comprised in an apparatus selected from the group consisting of: a laptop computer, a smartphone, a tablet, a portable electronic device, a vehicular audio system.
